(19) United States
(12) Patent Application Publication
(10) Pub. No.: US 2012/0290410 A1
(43) Pub. Date: Nov. 15, 2012

(54) ELECTRONIC CATALOG CONSTRUCTION

(76) Inventor: Mar Hershenson, Los Altos, CA (US)

(21) Appl. No.: 13/107,959

(22) Filed: May 15, 2011

(51) Int. Cl. G06Q 30/00

(52) U.S. Cl. 705/14.73; 705/26.7; 705/27.1

(57) ABSTRACT

Various method and systems concerning electronic calendars are described including constructing an electronic catalog where the constructing includes embedding in he electronic catalog a digital asset with an associated tag for triggering an automatic on line purchasing sequence and associated code for synchronizing comments made about the digital asset on the electronic catalog onto a social web site. Another method includes displaying digital media content on a computer display and in response to a user's input, incorporating a digital asset of the digital media content onto an electronic calendar. Another method includes receiving at a computer system changes, updates and/or promotions concerning items on an electronic catalog, and, notifying a user of the computer system of any of the changes, updates and/or promotions.

### FIELD OF INVENTION

The field of invention pertains generally to information processing in a networked environment, and, more specifically, to electronic catalog construction.

### BACKGROUND

FIG. 1 shows the face of a tablet computer 101. Notably, the face of a table computer includes a touch sensitive screen 102 that a user interfaces with in order to cause the tablet computer to perform useful routines. One interesting feature of a tablet computer is that documents or other displayable imagery 103 that are effectively larger than the size of the screen 102 can easily be made to slide in various directions so that the larger document is easy to peruse—even though it is larger than the tablet screen.

### BRIEF DESCRIPTION OF THE DRAWINGS

The present invention is illustrated by way of example and not limitation in the figures of the accompanying drawings, in which like references indicate similar elements and in which

FIG. 1 shows a tablet computer;

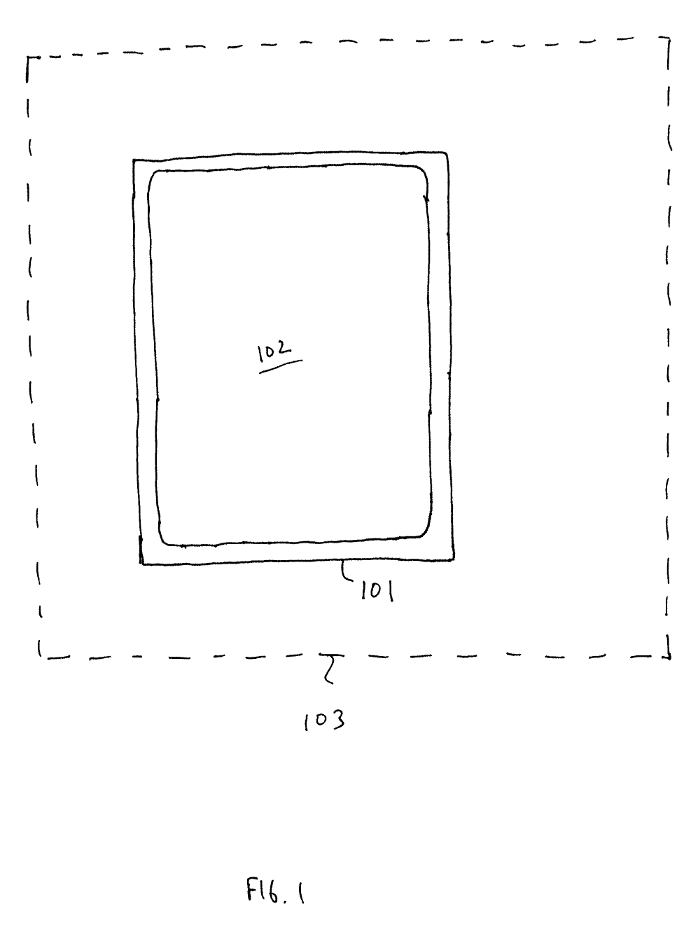

FIG. 2 shows a network environment including a catalog constructor;

FIG. 3 shows exemplary meta data that may be utilized by a catalog constructor;

FIG. 4 shows a process that may be executed by a catalog constructor;

FIG. 5 shows an architecture of a catalog constructor;

FIG. 6 shows a depiction of an electronic catalog;

FIG. 7 shows a depiction of meta data having relationships;

FIG. 8 shows a process for integrating digital media content into an electronic catalog;

FIG. 9 shows the pushing of information to an electronic catalog;

FIG. 10 shows the integration of a personal digital asset with an electronic catalog digital asset on a computer display;

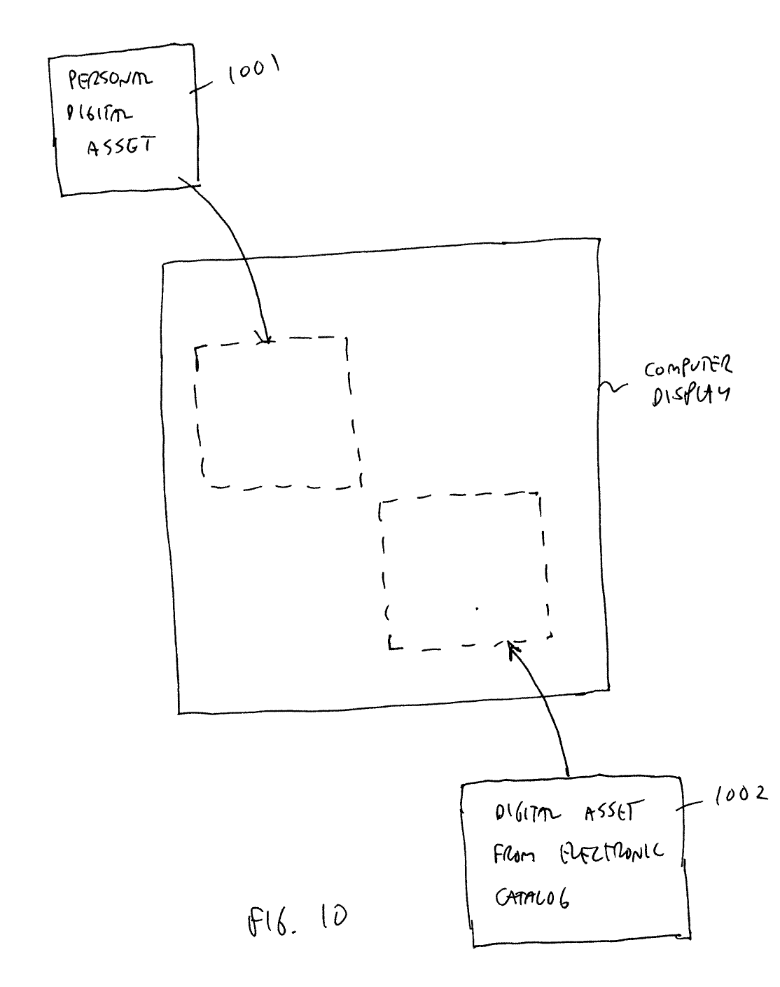

FIG. 11 shows an embodiment of a computer system.

### DETAILED DESCRIPTION

1.0 Electronic Catalogs

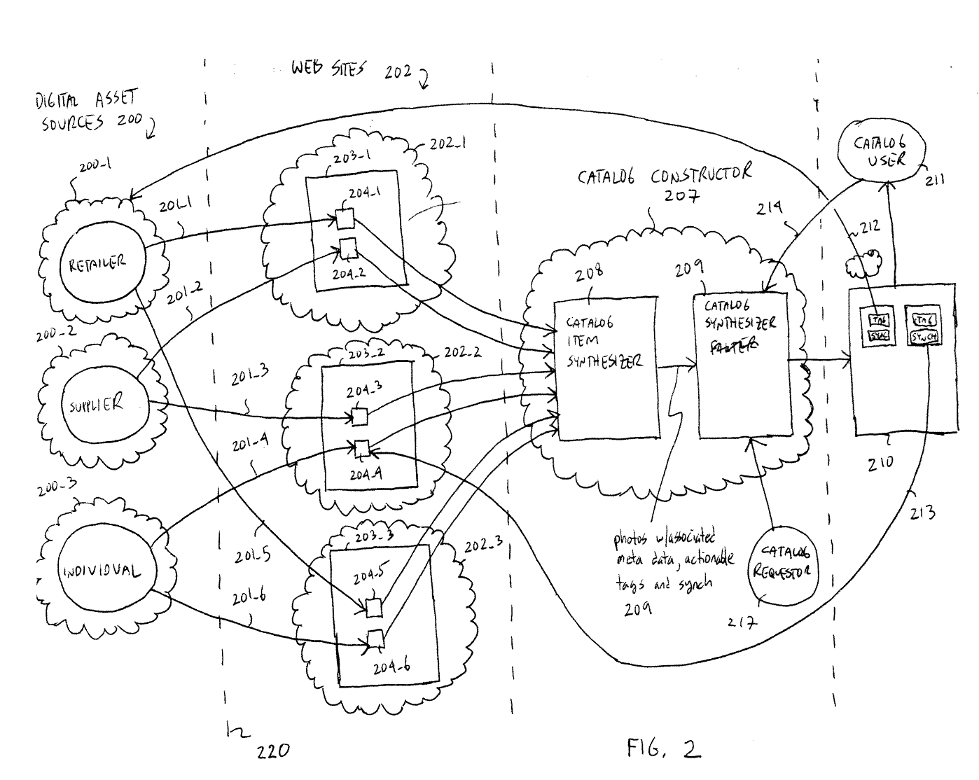

FIG. 2 shows an example of a system that is capable of extracting digital assets from various web sites, including social web sites for instance, and/or receiving digital assets from retailers, suppliers, product feeds, etc. and synthesizing them into an electronic catalog. An electronic catalog is a catalog that can be viewed on a computing system (e.g., personal computer (PC), laptop, netbook, tablet computer, smartphone, etc.). According to the system of FIG. 2, different digital asset sources 200 populate different websites with their respective digital assets and/or otherwise provide digital assets so that an electronic catalog constructor can receive them. As observed in FIG. 2, as a few examples, the digital asset sources may include any one or more of a retailer, a supplier and an individual. Although only one respective instance of each such digital asset source is observed in FIG. 2 it should be understood that many different retailers, suppliers and individuals can contribute digital assets as described herein.

A retailer can be viewed as a seller of goods and/or services. For example, a store (and/or franchise) that sells goods that are made and/or marketed by others is a retailer. A supplier is the initial source for a good or service such as a company that provides products of its own design and markets the products for sale. An individual can be a person or an organization of some kind such as a government organization or corporation. Note that, depending on the circumstances, a retailer can be an individual, a supplier can be an individual, a retailer can be a supplier, etc.

Respective information systems 200_1, 200_2 and 200_3 associated with each of the retailer, supplier and individual are observed in FIG. 2. Here, for instance, the information systems 200_1 of the retailer may correspond to the backend software and computing systems (e.g., servers) that supply digital assets to a store's/franchise's web page(s) on the Internet and/or source any on-line product feed (e.g., as provided through a backload application program interfaces(API)). Likewise, the information systems 200_2 of the supplier may correspond to the backend software and computing systems (e.g., servers) that supply digital assets to a supplier's web page(s) on the Internet, execute the supplier's B2B automated on line business processes and/or source an on-line product feed of the supplier. The information systems 200_3 of the individual may correspond, for example, in the case of an individual person, to the software and computing system used by the person to access and use information resources through a network such as the Internet.

As observed in FIG. 2, the respective information systems of the retailer 200_1, supplier 200_2 and individual 200_3 feed various digital assets 204_1 through 204_6 into various web sites 202_1 through 202_3, any one or more of which may be a social web site. The digital assets are rendered on the various web pages 203_1 through 203_3 of the various websites. Alternatively or in combination (not shown in FIG. 2), the sources 200 of the digital assets may provide product feeds or other flows of information that include digital assets that are sampled or otherwise obtained by a catalog constructor 207. A product feed, as is known in the art, is a continued stream of information, typically in the form of a text file or document (such as XML or RSS) that is sent into a network and “listened to” by recipients/user/subscribers of the feed. The text document is usually formatted in some fashion to contain product information. Product feeds may be provided by a supplier/retailer or by a third party (such as GoogleProduct, theFeed, and Bing).

A digital asset is typically some form of digital photograph or video clip. Exemplary file types include JPEG, .png, .mov, MPEG and JSON. As just a few possible examples, FIG. 2 shows: i) a retailer and supplier posting 201_1, 202_2 respective digital assets 204_1, 204_2 to a first website 202_1; ii) a supplier and individual posting 201_3, 201_4 respective digital assets 204_3, 204_4 to a second website 202_2; and, iii) a retailer and individual posting 201_5, 201_6 respective digital assets to a third website 202_3. Here, web sites 202_1, 202_2 and 202_3 may be any web site including a supplier's/retailer's respective own web site or even a social web site.

A social web site is understood to be a website that is fundamentally designed to let individuals express and/or describe themselves and/or otherwise interact with others socially in an open, networked fashion (e.g., over the Internet). Examples include Facebook (which is designed to let individuals “friend” one another as well as provide for the posting of bios or other descriptions of the individual and photos or images of the individual), Twitter (which is designed to let individuals acts as a source of information to the Internet), Flickr (which is designed to let individuals post their own respective photos and/or videos), blogs, etc. For convenience the following discussion will refer to web sites 202 as being social web sites even though any of web sites 202 need not be a social web site.

FIG. 2 shows the digital assets rendered by a same web site 202 as being rendered from a same web page. Although this particular approach is possible it should also be understood that the various digital assets may be posted across different web pages of a same web site. Moreover, the combinations of postings as between the digital asset sources and the web sites may vary from the specific combinations observed in FIG. 2.

A catalog creator 207 then collects some/all of the digital assets 204_1-204_6 and constructs an electronic catalog 210 from them. In an embodiment, the catalog 210 includes the visual images of the digital assets with added embedded code that causes useful functions to be performed such as: i) the triggering of an on-line purchasing sequence 212 for an item depicted in the digital asset; and, ii) synchronization 213 between comments added to the digital asset on the electronic catalog 210 and comments added to the digital asset on a web site page (such as a social web site page) from where the digital asset was collected by the catalog constructor 207.

The catalog constructor 207 can be any of a retailer, supplier or individual and may be implemented with any combination of automated (e.g., software based) and manual processes. A catalog constructor 207 constructs a catalog 210, for example, according to input information describing parameters of the catalog's desired content. According to one example (among a multitude of other possibilities), the catalog constructor 207 is a web site that provides electronic catalogs as an on line service to users of the web site, such as user 211. Here, user 211 provides input information 214 that the catalog constructor 207 web site uses to determine the content of the catalog 210 (e.g., type of purchasable items to be included in the catalog such as clothes and other further defining features such as type of clothes (e.g., shirts), color, retailer, supplier, age, gender, etc.). The web site creates the electronic catalog 210 and sends it to the user 211 over a network. The user 211 may then use the catalog on his/her computer such as a tablet computer. Notably, the user 211 may be any of a retailer, supplier or individual. In another usage case, the user 211 of the catalog 210 is also the creator 207 of the catalog. For example, a person on his/her tablet computer may use catalog construction software 208, 209 installed on the tablet computer to construct a catalog 210 according to desired parameters 214 specified by the person on the table computer.

In response to a request to create a catalog, the catalog constructor 207 produces a catalog 210 from collected digital assets that fit desired criteria/parameters associated with the input information 214. In an embodiment, the catalog 210 includes embedded on-line purchasing and comment synch code for the respective digital assets. The user 211 may be given an opportunity to view digital assets that were automatically chosen for inclusion in the catalog by the catalog constructor 207 and formally reject any such automatically chosen digital asset. Likewise, the user 211 may also be given the opportunity to review digital assets that were not automatically chosen for inclusion in the catalog and formally include any such automatically rejected digital asset.

The same user 211 may then use the newly created electronic catalog 210 to purchase and/or comment on items displayed in the catalog. Alternatively or in combination, the catalog creator 207 or user 211 may share the newly created catalog through a network to other individuals so that the other individuals have an opportunity to purchase and/or comment on the items displayed in the catalog. For instance, if user 211 is a person, the person may upload the electronic catalog 210 to a social web site and permit it to be shared/viewed, by the individual's friends, friends-of-friends, etc. Here, notably, providing people with the ability to publish their own personally created catalogs according to their own tastes and then share them with their on-line friends is apt to be an effective marketing/sales device as friends are not only apt to have similar tastes and interests but are also apt to be interested in each others' catalog(s). Through the aforementioned embedded synchronization code, the friends can comment on a certain asset in the catalog and these same comments may then be posted on the asset's original post in the social web site from where it was collected. The person's friends may also publish and share their own catalogs that the person likewise can receive and view. Here, friends are sharing catalogs amongst themselves that they have individually created. This allows friends to compare each other's tastes and likes in a multi-directional fashion.

Although the above example was written with a view toward the individual as an individual person, various organizational individuals may also make use of customized and automated catalog construction technology. For instance, a private school may not require uniforms but may have a strict dress code. A customized and automated catalog construction tool can be utilized by directors of the school to construct a catalog of clothing that is appropriate as to the school's dress code, for example, across a spectrum of retailers and suppliers, and publish the catalog to the school's students and/or parents of the school's students on a social web site or on the school's own web site. The students/parents can then fetch the catalog from the web site to view apparel deemed appropriate for the school's dress code.

Likewise, retailers and suppliers may also make use of automated catalog construction technology to create their own electronic catalogs. Electronic catalogs (like any of those described above in the preceding examples) may also include digital assets posted by people who, for example, posted photos of themselves in certain garments on a social web site (postings 201_4 and 201_6 may be examples of this). As such, for instance, the on line catalogs of suppliers and retailers may include imagery of people other than traditional, professional models. The postings by such individuals may be made on a web page of a supplier or retailer that the supplier/retailer posted on the social web site, and, these same postings may later appear in an electronic catalog of the supplier/retailer.

As discussed above, the catalog constructor 207 can be implemented, for instance, as a web site that constructs electronic catalogs as an on line service. In this case, for instance, an individual (including a retailer and supplier) who seeks to construct a catalog would create a session with the web site, enter the criteria for selecting digital assets for inclusion in the catalog, and receive as a result the constructed electronic catalog 210. Note that in the case where a retailer or supplier seeks to create a catalog, the catalog requester 217 is not so much as a user of the catalog but a provider of the catalog. As such, the input criteria 215 used to determine the content of the catalog is a retailer or supplier. Alternatively from a publicly available web site, the catalog constructor 207 may be implemented as an instance of software within an individual's information system. For instance, in the case of a corporation, the catalog constructor 207 may be a software tool that runs on the corporation's internal computing systems. In the case of an individual person, the catalog constructor 207 may be a software tool that is installed on the person's personal computing system. Architecturally, the catalog constructor 207 may be split so as to have a client part and a server part. If so, the server part may be instantiated on a private server (e.g., within a corporation's IS infrastructure) or a public server that is reachable, for instance, over the Internet.

Given that the catalog constructor 207 creates an electronic catalog 210 based on specified input parameters (e.g., 214 or 215) specified by an individual that desires the creation of a catalog, the catalog constructor 207 is essentially responsible for intelligently selecting certain digital assets for inclusion in the catalog while intelligently rejecting others.

2.0 Meta Data and Electronic Catalog Construction

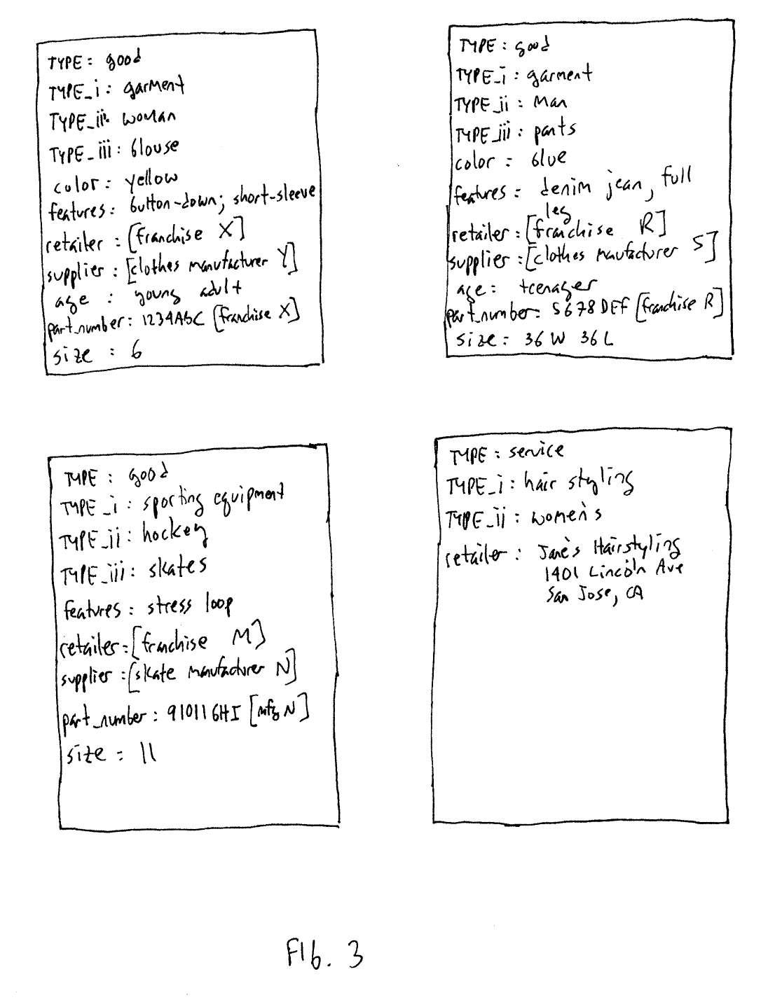

In an embodiment, a body of meta-data is associated with each digital asset and kept/managed by the catalog constructor 207. The meta-data essentially describes the one or more purchasable items rendered in the visual imagery of a digital asset that may be incorporated into an electronic catalog. FIG. 3 shows exemplary meta-data structures for different purchasable items that may appear across different digital assets for instance. Notably, the meta data profiles may include a specific retailer/supplier and associated part number, SKU character or other specific product identifier. Additionally, some of the meta-data may pertain to the web site or product feed that a digital asset was collected from. Examples include, in the case of web sites, the name of the web site where the digital asset was posted, an identifier of the page and/or subject matter associated with the page of the website from which the digital asset was collected, and, an identifier of an individual that sourced the digital asset to the web site In the case of product feeds the meta data may identify the feed, information on how the feed is accessed and/or any information on how the received feed (e.g., text file or document such XML or RSS documents/files) is formatted so that it can be appropriately parsed. Even further, as described in more detail further below, such meta-data may include code or information useful for constructing code that triggers an on-line purchasing sequence for the item to which the meta-data pertains and/or permits comments made about the asset on the catalog to be synchronized with comments made on its original web site web page.

Thus, in order to select certain items for inclusion into a requested electronic catalog, the catalog constructor searches through the meta data for items that effectively match input criteria specified by the individual who desires the creation of the catalog. Meta data profiles may, therefore, be stored in a searchable database. With the understanding that meta-data exists for the digital assets, there are various ways in which the meta-data may be correlated to its respective digital asset so as to be useable to the catalog constructor 207.

On one end of the spectrum, referred to as a front end approach, the meta-data associated with a digital asset is included with the digital asset by it original source 200 before it is posted on websites 202. For example, retailers/suppliers/individuals may post digital asset images on various web sites where the posted digital assets have embedded meta data used by the catalog constructor 207 (e.g., pricing information, supplier/retailer of depicted good/service, description of depicted good/service, targeted gender, target age, targeted ethnicity, etc.). In this case, the correlation between a digital asset and its meta-data is straightforward as it is essentially given to the catalog constructor 207 along with the digital asset. In another effectively front end approach, comprehensive meta data profiles for digital assets are sent to a catalog constructor 207 directly by the digital assets' respective original source(s) 200. Each meta data profile has an “identifier” that identifies a particular digital asset and/or imagery therein. Digital assets are then posted on web sites (e.g., social web sites or other types of web sites) with respective embedded identifiers. The catalog constructor 207, e.g., as a constant background process, scans these web sites for digital assets, stores them in a database and flags their respective embedded identifiers. By matching an asset's embedded identifier with an identifier of the pre-supplied meta-data, the catalog constructor can correlate a digital asset to its meta data. With front end approaches, changes to meta-data (such as a price change for a product) are easily effected. For example, if the price of an item changes, the supplier/retailer simply sends the catalog constructor an updated price for the identifier associated with the item. The catalog constructor 207 updates its meta-data accordingly.

In the case of a “front-end” approach, as discussed above, the meta-data for a digital asset may include or be appended to the digital asset from its original sources. For example, a retailer 200_1 and individual 200_3 may append suitable meta-data to respective digital assets that they post to respective web sites 202. Here, the websites may have some feature of their respective APIs or other data interface/specifications that permit the inclusion of such meta-data along with the digital assets that they post (e.g., a “miscellaneous” field of suitable information size and/or a field for a link to miscellaneous data). In more direct approaches the web sites may even adopt their systems to knowledgeably accept and store/manage/organize the meta-data associated with the posted digital assets. This meta-data may then be provided to the catalog constructor. In an even further embodiment, line 220 of FIG. 2 corresponds to an industry-wide standard that articulates the structure of the meta-data so that the manner of specifying meta-data for digital assets by their individual sources is standardized and transparent to whichever web site the sources decide to post their respective digital assets on.

In another front end approach, one or more automated product feeds (such as Google Product, Commission Junction, theFind or a product feed provided by a supplier/retailer) are enhanced to include or otherwise refer to digital assets that include respective images of the products/services that the product feeds provide information about. Here, the catalog constructor 207 can obtain a correlation of obtainable digital assets/images to pertinent meta data simply by receiving the product feed. Here, automated product feeds (from the supplier/retailer or from a third party) may also be received by the catalog constructor to update its meta data in response to product/service changes such as pricing changes, discontinuations, etc.

On the other end of the spectrum, referred to as a “back end” approach, the catalog constructor 207 determines the correlation between a digital asset and its respective meta data. Here, the product lines of various retailers and/or suppliers are made available to the catalog constructor 207 separately and/or with little if any relationship to the reception of the digital assets by the catalog constructor 207. For example, the catalog constructor may receive one or more automated product feeds that do not include digital imagery of the products/services to which the product feed(s) pertain. The catalog constructor may also separately receive digital assets of the products/service that are not correlated in any way to the information in the product feed. In one embodiment, suppliers/retailers of the products/services generate the product feed and provide the digital assets received by the catalog constructor—but they do not correlate them. Instead the catalog constructor has to perform the correlation (e.g., manually).

In one embodiment, alternatively or in combination, the meta data profiles are adapted to also include a digital image of an individual item or a description of an image of the individual item. Correlation between the meta data and received digital assets are then effected by comparing the visual image of the meta data with the visual image of a received digital asset. For example, the catalog constructor 207 might automatically and repeatedly, as a constant background process, scan websites for digital assets that are suitable for inclusion in a catalog. As new digital assets are collected from the web sites, the catalog constructor 207 flags the specific supplier/retailer a particular digital asset is associated with. The catalog constructor then queries a product feed of the supplier/retailer and queries its own internal database which presents images of products/services for that supplier/retailer that are stored in the database and that are identified in the product feed. The stored digital assets may have been received separately from the supplier/retailer, collected earlier from a scan of websites or combination of both. The catalog constructor (e.g., manually or automatically) compares the image of the newly received digital asset against the image(s) for the supplier/retailer kept in the catalog constructor's database. Matches result in a correlation/linkage between a specific digital asset collected from a website and its corresponding meta-data.

According to one approach, the visual search process may be outsourced to a web service, such as IQEngines, that specializes in visual searches. In other embodiments, visual searches may be done manually (e.g., again with an outsourced web service such as SamaSource). In a further embodiment, if an electronic visual search engine approach fails a back-up manual search process is attempted. Once a match is found for a digital asset, the digital asset may then be stored in the catalog constructor's database with an association to its respective meta data.

Subsequent changes to meta data such as pricing changes or discontinuation of products/services may be effected with a back end approach (catalog constructor discovers the changes) or a front end approach (catalog constructor is notified of the changes (e.g., from an automated product feed).

Regardless if the catalog constructor's meta data is realized with a front end approach, a back end approach, or some combination thereof, the catalog construction process continues by: 1) searching the database's meta-data for “hits” in view of the requester's input criteria information 214/215; and, 2) extracting the digital assets for those items of meta-data that registered a search hit. In an embodiment, rather than store digital assets in their entirety into the catalog constructor's database, the meta data is configured with links that identify where the digital assets can be found. In this case, for example, catalogs are created by using the associated links to fetch the digital assets from the network (e.g., from their web sites) for those items of meta-data that registered a search hit. An approach that stores digital assets in the catalog constructor's database and that uses links may also be taken.

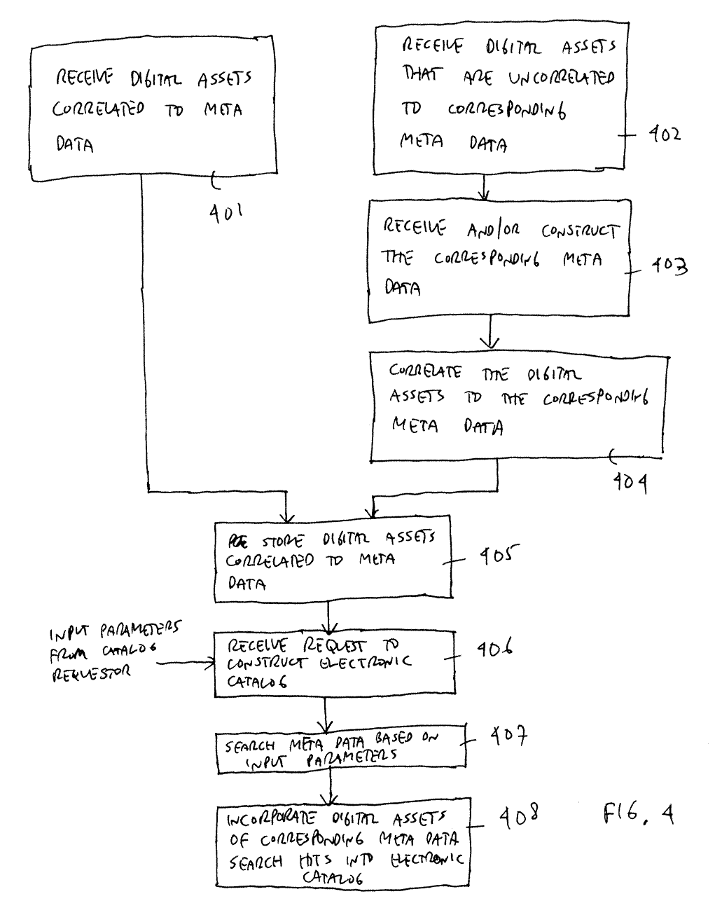

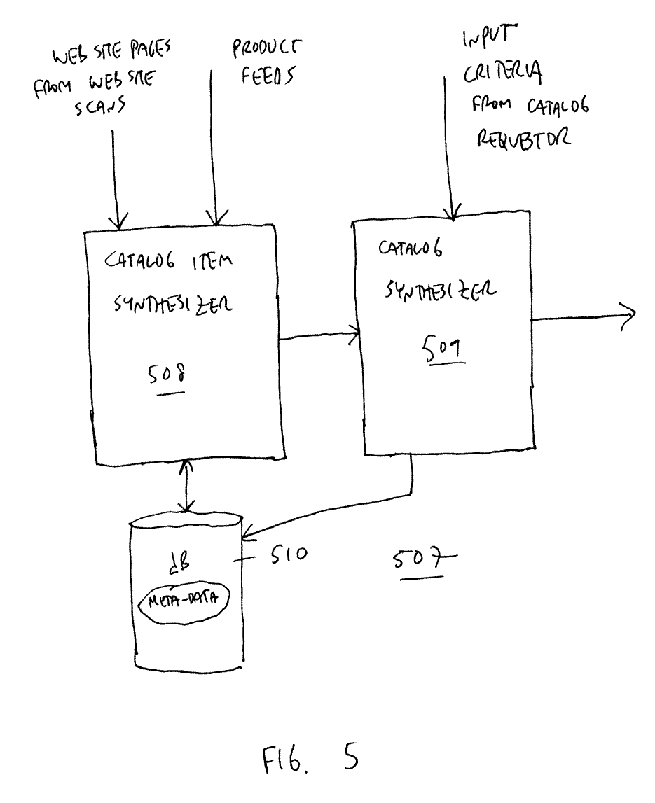

FIGS. 4 and 5 pertain to a method and architecture for a catalog constructor. A catalog item synthesizer 508 may: 1) receive digital assets correlated to its corresponding meta data 401 (such as a product feed that is enhanced with digital assets of the products it feeds information about); and/or, 2) receive digital assets that uncorrelated to corresponding meta data 402 (e.g., from web page scans), receive (e.g., from a standard product feed) and/or construct (e.g., manually) the corresponding meta data for the digital assets 403 and correlate the digital assets to its corresponding meta data 404. The catalog item synthesizer 508 may process any received or constructed information and condition it for storage into a database. The catalog item synthesizer 508 also stores 405 the digital assets correlated to their respective meta data into a database 510.

A catalog synthesizer 509 receives 406 a request to construct an electronic catalog and input criteria from a catalog requester. The catalog synthesizer 509 in response searches 407 the meta data in the database 510 based on the input criteria. The catalog synthesizer 509 then incorporates 408 the digital assets that correspond to the meta data the produced a search hit in order to produce an electronic catalog.

3.0 Embedded Tags and Synchronization Code

As discussed above, the meta-data may also include program code that is to be embedded or otherwise associated with the digital assets selected for inclusion in the electronic catalog (“program code” can include computer readable textual content and/or instructions, scripts or other types of executabler processable” software).

For example, according to one approach, the meta data includes information to insert a “tag” into the digital asset and/or its associated information that is incorporated into the catalog. In an embodiment, program code of the electronic calendar associated with a tag performs the following routines: 1) detects that a user has tapped on (e.g., in the case of touch sensitive user interface and display) or selected (e.g., with a cursor and a mouse click) an image of the digital asset in the catalog that the tag is associated with; 2) in response to the detecting of the tapping/selection, triggers a pop-up window or the sudden appearance of another specialized displayed feature that provides information on the selected digital asset such as: 1) a supplier/retailer; 2) product identifier (e.g., SKU number); 3) price; and, 4) a “buy” button or other GUI feature that, when tapped/selected by the catalog user, causes an on-line purchasing sequence to initiate for the item that the digital asset renders an image of. For instance, upon the user tapping the buy button, a connection is established to an automated product feed for the item (as provided by the retailer/supplier of the item to be purchased or by a third party), and/or, a connection is established to the catalog constructor's web site which periodically samples product feeds (e.g., on a daily basis) and updates its meta-data accordingly (i.e., when the user taps on the buy button, an inquiry into the catalog constructor's meta data is made). The digital asset's meta deta may include the information needed to establish the connection. This meta data is also embedded into the electronic catalog for use when the user taps on the buy button after tapping the digital asset on the catalog. Tags are discussed in more detail further below.

In an alternative approach, rather than have the information suddenly appear in response to the user affirmatively selecting an item in some way, the visually displayable content of the digital asset may be modified to visually integrate the information (e.g., supplier/retailer; product identifier; price; buy button) into the digital asset so that it appears along with a purchasable item as the standard imagery that is rendered by the electronic catalog.

Notably, some digital assets may include multiple tags for different purchasable items with different corresponding suppliers/retailers. For example, an individual may post an image of himself/herself with a shirt from a first retailer/supplier, pants from a second different retailer/supplier, shoes from a third different retailer/supplier and an accessory (e.g., a pocketbook or tennis racket) from a fourth different retailer/supplier. The visual search process or supplied meta-data (e.g., in the front end approach) would identify all four purchasable items and, correspondingly, four separate tags would be embedded in the digital asset at the appropriate position in the digital asset where each tag's corresponding item appears. As such, when the user taps on or otherwise selects a specific one of the items, the sudden appearance of corresponding information and buy button/feature for the specific item is displayed.

In an embodiment, the format of the tag is standardized or otherwise made available to suppliers/retailers for example so the tag can be included with the digital asset when it is originally posted or otherwise made available from its source.

According to a second feature, comment and comment synchronization code may be incorporated into the electronic catalog for its selected digital assets. Here for instance, if a digital asset is collected from a social web site page that permits comments from individuals pertaining to the digital asset to be posted on the web page (e.g., beneath the digital asset) or elsewhere, the catalog constructor 207 embeds code into the catalog for the digital asset that not only permits comments to be posted on the catalog for the digital asset, but also, causes any such comments that are posted on the catalog to also be posted on the social web site page where comments for the digital asset are found. For instance, an individual may post digital assets of himself/herself on a social web site where the social web site permits comments to be posted by others beneath the image of the digital asset. An electronic catalog is then created with the digital asset and users of the electronic catalog post comments on the electronic catalog that pertain to the digital asset (e.g., a comment that a displayed shirt looks good with a displayed pair of pants). The comment that is entered on the catalog is then, by way of the embedded synchronization code, automatically posted as commentary for the digital on the social web site page where it was originally posted (e.g., beneath where the digital asset is rendered).

In an embodiment, automatic synchronization is made an option that is enabled/disabled either during the catalog construction stage (e.g., so that if the catalog constructor 207 does not want synchronization for particular digital assets, the synchronization program code is simply not included in the catalog accordingly), or, during use of the catalog (e.g., so that if a user of a catalog enters a comment on a catalog, the user has the option to permit or deny the reposting/synchronization of the comment on the digital asset's original social web site). The option to permit/deny synchronization may be rendered as a GUI feature (e.g., “permit synchronization ?”, “comment private or public”, etc.) with checkboxes or other selectable feature that permits the user of the catalog of the control the synchronization of his/her comments on the catalog.

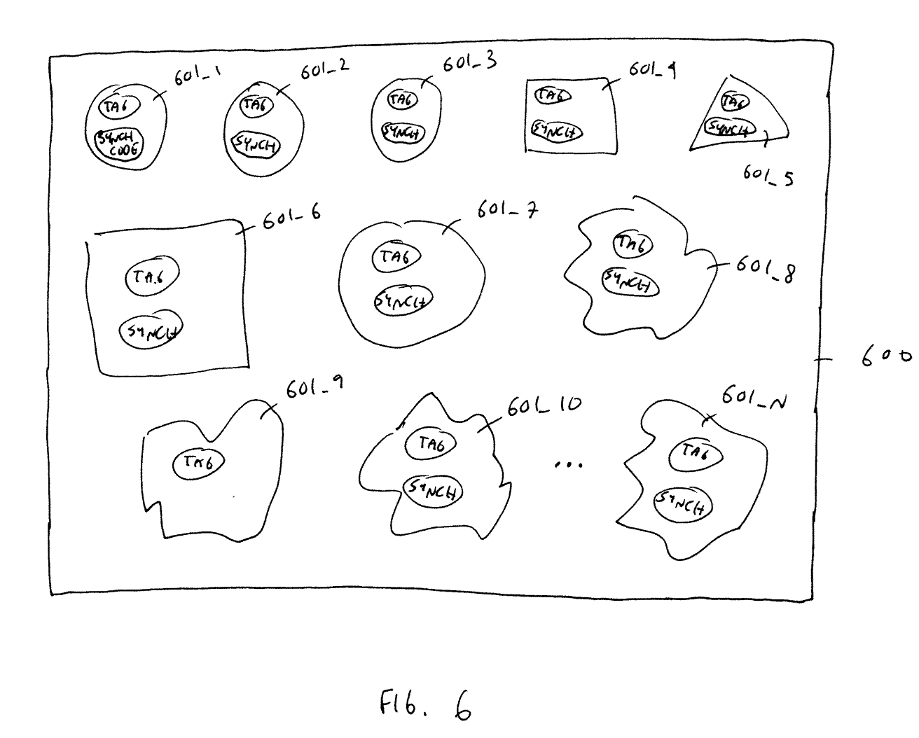

FIG. 6 shows an electronic catalog 600 having various digital assets 601_1 through 601_N each having associated/embedded tag and synchronization code as discussed above. Note that in various embodiments not every digital asset of an electronic catalog has both tag and synch code. Some digital assets may have no such code or only code for one of these functions.

4.0 Meta Data Relationships

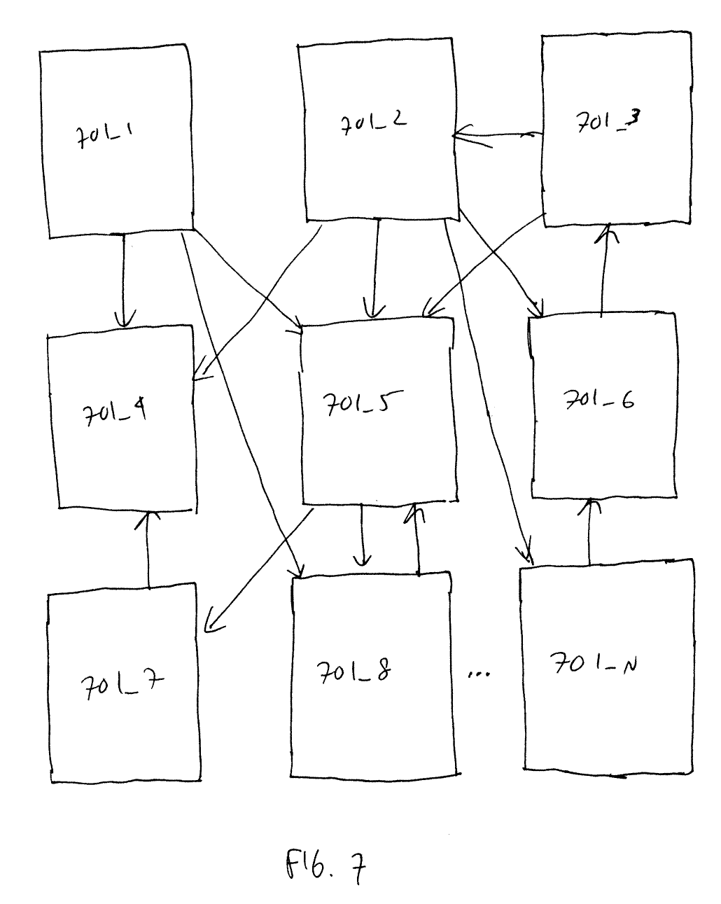

In a further embodiment, the instances of meta-data for the digital assets are designed to specify relationships where appropriate between their associated products/services. For example, if a certain product is deemed to have a strong relationship to another product in the sense that a person who would be interested in buying one of the items is also apt to be interested in buying another of the items (e.g., a NY Yankees T shirt and a NY Yankees baseball cap), the relationship is recorded in the meta data. FIG. 7 shows a high level depiction of a collection of respective meta data items 701_1-701_N for digital assets having various relationships as signified by the depicted arrows.

In an embodiment, when the meta data is searched in response to a request to create an electronic catalog, and a “hit” results on one of the items, if a strong relationship is recorded for the hit upon item to another item, the other item is also automatically selected for inclusion in the electronic catalog even though by itself it did not result in a hit. Here, a number of relationship hops can be specified for automatic inclusion into an electronic catalog (e.g., as a default or as input criteria information specified by the electronic catalog construction requestor). For example, if the number of hops is “2”, a hit on any product/service meta data having a relationship to additional meta data will result in the automatic incorporation of the products/service of the additional meta data into the catalog. Any products/services having a relationship to the additional meta data is also automatically incorporated.

In a further embodiment the search criteria entered by the individual that requests an electronic catalog may also specify items that are not to be included in the catalog. If a strong relationship flows from a search hit item to another item that falls into the category of items that were specifically not to be included in the catalog, then, the other item is not automatically included in the electronic catalog.

Here, the relationships themselves can be determined from analytics processes that indicate certain correlations in the sense that people who have purchased a first item are apt to purchase a second item. The items need not be, on the surface, related in any way (e.g., NY Yankees T shirt and music by Bach). In an embodiment, a retailer/supplier forwards to the catalog constructor analytics data (and/or relationship data based on analytics) to the catalog constructor. In response, the catalog constructor incorporates corresponding relationship data into its corresponding meta data. A single item may have multiple relationships to a plurality of other items. Relationship data may also be used to incorporate “next best fit” replacement processes into the electronic catalog construction process. For instance, the catalog constructor's meta data may be periodically updated to reflect changes in the associated products/services such as price changes and/or product/service discontinuations. In the case of a product/service discontinuation, the meta data for a discontinued product/service will be updated to reflect that the product/service has been discontinued. If a search hits on the meta data of a discontinued item, the item will not be incorporated into the electronic catalog being constructed. However, if the meta data for the discontinued item has a relationship to another, similar product/service, that product/service will be incorporated into the electronic catalog as its replacement.

The catalog constructor 207 can also contribute to the production of analytics data and share it with one or more suppliers/retailers. Here, notably, it is envisioned that products/services from multiple suppliers and retailers may be incorporated into a single an electronic catalog based on the input criteria from various catalog users. In a further embodiment, the catalog constructor incorporates program code into an electronic catalog that is designed to “report” (e.g., back to the catalog constructor) the purchasing of any items from the electronic catalog. Here purchasing correlations between different suppliers/retailers may be flagged that otherwise would have gone unnoticed. For example, if a number of electronic catalogs are produced for different users that include all the materials for a place setting (silverware, placemats, dishes, etc.) a pattern may be reported from the electronic catalogs that a certain style of place mat and certain style of dish are frequently being purchased together. Here, the place mat supplier and dish supplier may have no relationship and would never have known of the correlation but for the behavioral pattern reported out from the electronic catalogs. This analytic data may be, for instance, reported to the catalog constructed who reports it to both the place mat supplier/retailer and the dish supplier/retailer. Because of the “open ended” search criteria that may be given to the catalog constructor, catalogs having widely varied and unrelated items may be incorporated into a single catalog. In this case, relationships may be detected between seemingly unrelated products/services.

5.0 Embedded Tags in Electronic Media and Associated Applications

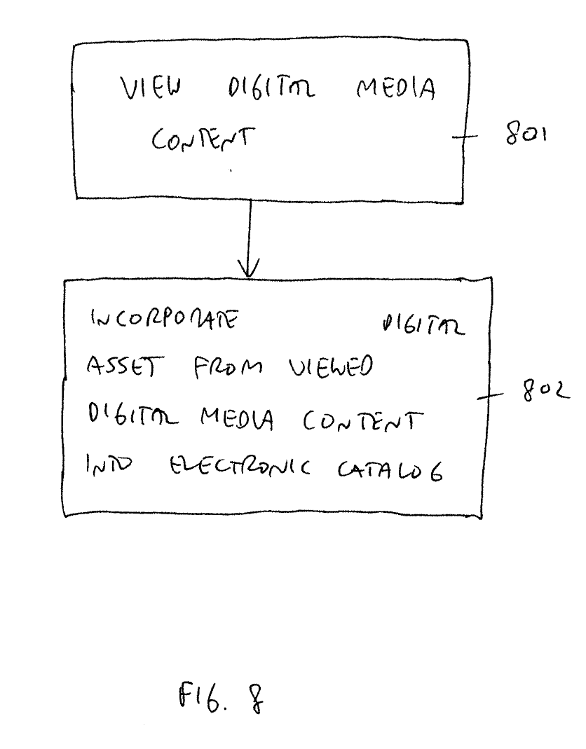

In another approach, digital media—such an electronic magazines, web pages, blogging sites, video repository sites, digital content provider sites or services, etc. may have integrated advertising content (such as a specific add or an image in an editorial, etc.). The advertising content may include a digital image such as a picture of a product/service being advertised. Here, recalling that the format of the “tag” may be standardized or otherwise made available, the digital image of the advertisement may have the same associated “tag” information described above in the same format as constructed by a catalog constructor for inclusion into an electronic catalog. Thus, for instance, referring to FIG. 8, a person may be reading an electronic magazine (e.g., on his/her tablet computer) and see an advertisement for an item 801. The user may select the item (e.g., by tapping it) to trigger an on line purchasing sequence as described above. Additionally, the digital image for the advertisement may be additionally formatted identically (or at least sufficiently) for inclusion into an electronic catalog. In this case, in response to the person tapping or selecting the advertisement/image, the digital image and its embedded “tag” information may be “copied over” to an electronic catalog of the person.

The electronic catalog may be already existing. For example, before reading the electronic magazine on the tablet computer, the user may have previously navigated on the tablet to a catalog constructor web site and had a catalog created (e.g., for the person or someone else the person knows). Upon subsequently reading the electronic magazine on the tablet, the person may tap twice on the digital advertisement to effect a “copy” of it (and its embedded tag information), close the magazine application, open the catalog and paste the digital image of the advertised item in the created catalog 802. With the compatible tag information, the person can later choose to purchase the item from the magazine “as if” the item had been included in the catalog originally by the catalog constructor. Additional items from other electronic media (e.g., other electronic magazines, one or more web pages, etc.) may also be included in the catalog.

Moreover, note that a single user may have more than one catalog, e.g., organized by subject matter. For example, a user may have a first catalog that corresponds to an accumulation of items that the user might wish to buy for his/her spouse at some point in the future (e.g., for the spouse's birthday or for Christmas), a second catalog that corresponds to an accumulation of items that the user might wish to buy for his/her child at some point in the future, a third catalog for possible Christmas presents, etc. As the user reads electronic media such as electronic magazines such and or other web pages, and incorporates various tagged items from such content into his/her respective catalogs, the catalogs will build up over time and, for instance, when the user finally decides to purchase an item, the appropriate catalog essentially corresponds to an electronic of the interesting items that have been viewed in the past as possible future purchase options. Here, the user may also copy and paste one portion of a first catalog into another portion of a second catalog. So, for instance, if a group of items on a catalog for a particular person could also service as interesting possible Christmas presents generally, the set of items may be copied from the catalog dedicated as possible purchasing options for the person and pasted into the catalog dedicated to possible general Christmas presents.

6.0 Synchronization of Product/Service Changes to the Catalogs

Recall that tags may be embedded or otherwise associated with digital assets to trigger the beginning of an on-line purchasing sequence. As stated above, in an embodiment, program code associated with a tag performs the following routines: 1) detects that a user has tapped on (e.g., in the case of touch sensitive user interface and display) or selected (e.g., with a cursor and a mouse click) an image of the digital asset in the catalog that the tag is associated with; 2) in response to the detecting of the tapping/selection, triggers a pop-up window or the sudden appearance of another specialized displayed feature that provides information on the selected digital asset such as: 1) a supplier/retailer; 2) product identifier (e.g., SKU number); 3) price; and, 4) a “buy” button or other GUI feature that, when tapped/selected by the catalog user, causes an on-line purchasing sequence to initiate for the item that the digital asset renders an image of. For instance, upon the user tapping the buy button, a connection is established to an automated product feed for the item (as provided by the retailer/supplier of the item to be purchased or by a third party). The digital asset's meta deta may include the information needed to establish the connection.

Here, various tag implementation architectures are possible. For instance, according to one approach, program code that detects that a user has tapped on or otherwise selected an image of an item and, in response, triggers the opening of a pop-up window is executed locally on the computer system on which the electronic catalog is rendered. With respect to the specific information within the pop-up window (supplier/retailer; product identifier, price) the information may also be kept locally on the computing system that renders the catalog, or, the embedded tag may have a link or other network address to the catalog constructor's meta data for the selected item such that the specific information within the pop-up window is downloaded to the pop-up window over the network in response to the user tapping/selecting the item.

Recalling that updates to the catalog constructor's meta data in view of changes such as pricing changes have already been discussed above, note that the later approach (downloading from the catalog constructor's meta-data) automatically ensures that when the user taps on the item, the information for the item that appears in the pop-up window will be up-to-date. That is, since the information in the pop-up window is taken from the catalog constructor's meta data and the catalog constructor's meta data is up-to-date, the information that appears in the pop-up window will automatically be up-to-date.

In the former approach (information is kept locally on the computing system that presents the electronic catalog), the electronic catalog is automatically kept synchronized with the product/services by the catalog constructor. For example, each electronic catalog has a network address or other identified that permits the catalog constructor to periodically send information to the electronic catalog after it has been created and provided to the user. The catalog constructor keeps a record of each catalog and its contents. When the catalog constructor becomes aware of a product change that effects one of the items on the catalog, the information is automatically sent to the electronic catalog and incorporated therein. For example, if the price on a certain item changes, the catalog constructor sends the price change to the catalog which incorporates it into its local meta data for the affected item. If the user taps on the item, the latest price is correctly displayed.

In a more distributed approach, the electronic catalog has embedded or associated code that is sophisticated enough to, from the computing system on which the electronic catalog is displayed, tap into an automated product feed to update a tag's associated item. That is the catalog's embedded code is designed to seek automated product feeds for its associated items to detect changes and incorporate those changes locally on the catalog. In this case, the catalog constructor need not automatically send synchronization messages to the electronic catalog. The catalog constructor may, however, assist a catalog's embedded/associated code establish a connection to, or act as an intermediary between, a product feed. For instance the catalog's embedded/associated code may ping a catalog constructor's web site which, in response, returns information that informs the code where to get product feed information, or, may connect to the product feed itself on the code's behalf and forward any changes to the catalog.

In another approach, once an item is incorporated into a catalog, the presence of the item on the catalog is registered with the supplier/retailer of that item. Any future changes affecting the item are then automatically sent to the catalog by the retailer/supplier (rather than the electronic catalog constructor).

In the case of product discontinuations, by any of the mechanisms described above, a discontinued product may be automatically removed from an electronic catalog. In a further embodiment, if the discontinued product/service has a relationship to another, related item (e.g., a newer updated version of the discontinued item), new information to incorporate the related item into the catalog in place of the discontinued item is automatically sent to the catalog for automatic incorporation. Regardless if a product discontinuation exists or not, the introduction of a newer updated version of an item on a catalog may be automatically incorporated into the electronic catalog as an automatic update to the catalog. A preference to automatically receive such updates or not automatically receive such updates may be specified by a user of the catalog. In a similar fashion, updates to relationship meta data of an item on a catalog may also be reflected as updates to the catalog. For instance, if a catalog constructor's or retailer/supplier's relationship data for an item on a previously constructed electronic catalog changes, such as the addition of new relationships, the items identified by the new relationships may be automatically incorporated on the electronic catalog. Again, in an embodiment, such automatic updates may be enabled or disabled by a user of the catalog.

By any of the mechanisms described above, a pricing change may also be accompanied by some kind of highlighted information such as “SALE!” or other promotional or advertisement-like communication. This information is rendered on the catalog in a manner that visually associates it with the item having a pricing change (such as putting “SALE!” across or beside the image of an item having its price reduced).

Moreover, in another embodiment, e.g., where the individual digital assets of an electronic catalog are registered with their respective suppliers/retailers, a specific supplier/retailer will know which ones of its products/services are instantiated on a single catalog. With a network address for the catalog (and/or the user and/or creator of the catalog) also being known, the supplier/retailer can push additional messages and/or content to the user and/or creator of the catalog for consideration for purchase, for inclusion in the catalog, etc. For example, if a user/creator of a catalog has instantiated five items from the same supplier on his/her catalog, the supplier might “tempt” the user/creator into purchasing the items by sending an on line offer (e.g., by email or that appears on the catalog) that offers to give the specific user a 20% discount if he/she purchase all five items on the catalog (or some subset of them). Alternatively, the supplier/retailer might send a digital asset of a sixth item (e.g., for inclusion on the catalog) an offer to give the sixth item to the user for free if he/she buys all five items (or some subset of them, etc.).

On a related note, the catalog creator may include a recommendation engine or otherwise execute recommender processes to make suggestions to a requestor of a catalog or hidden from the requester, e.g., as part of the catalog construction process, of certain goods/services and/or suppliers/retailers. Recommendation processes may also be executed after the construction of a catalog and be pushed to the user. The recommendations may be based on the aforementioned relationship data or may be executed as a separate process. Possible suggestions that may be made include, among other possibilities: 1) catalogs/stores to subscribe to (e.g., a user may like west elm and DWR so the recommendation process would recommend heath ceramic); 2)pages to be served (e.g., a user might tend to buy just sales item so pages with sales would be served first); 3)layout of a page (e.g., a product has high inventory so it would choose a page layout that would show a larger image for that product); 4)outfits (e.g., as is already performed in the prior art, if a user adds a shirt to the cart based on his/her history and what other people buy the recommender process can recommend the next page to show, or product to show). For catalogs that are already existing, the context of the suggestion may take the form of a pop up from the catalog or the incorporation of new information into the catalog.

In a further enhancement, any item on a first user's catalog can be “pushed” to the catalog of other users. For example, in the case where a number of friends are sharing each other catalogs, a particular user may receive an automatic update that one of the items on her catalog is now on sale at a reduced price. In an embodiment, the update will also be automatically be provided to each instance of her catalog on the computing systems of her friends with whom she has shared the catalog. Alternatively, the update may not be automatic. Instead the user may be give the option to manually push the update to only selected ones of her catalog based on which of her friend she wants to notify of the change.

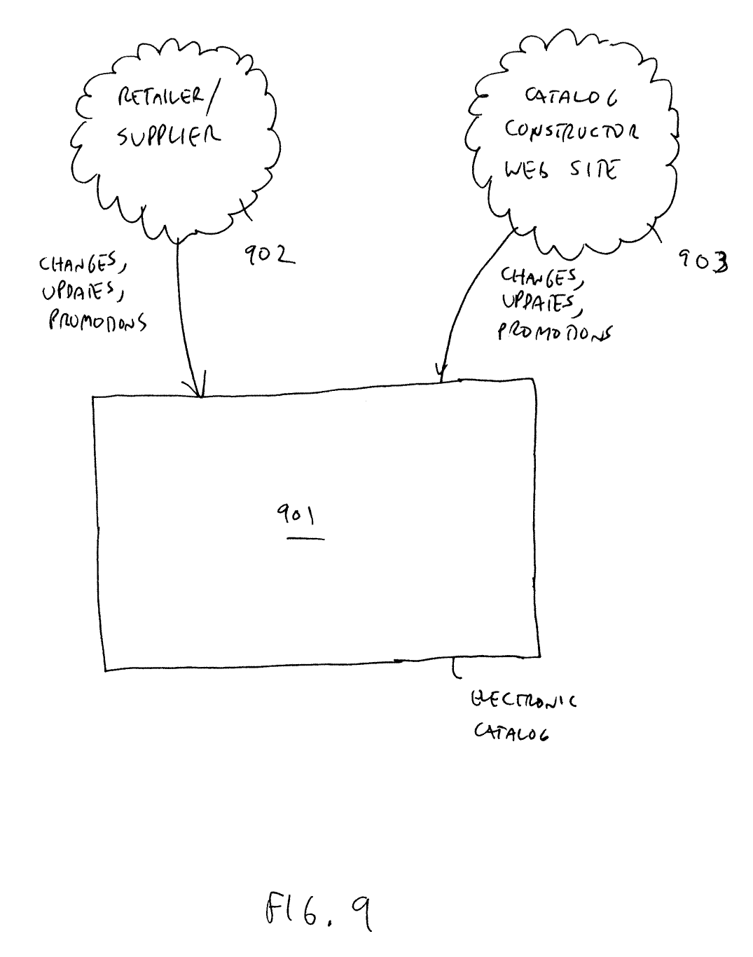

Thus, as discussed above, and as observed in FIG. 9, changes, updates, promotions, etc. may be pushed to an already existing electronic catalog 901 from a supplier/retailer 902 and/or catalog constructor 903.

7.0 GUI Features

The user of an electronic catalog may use and/or otherwise view the catalog through a graphical user interface that has a number if useful features built. An example includes:

“My closet”—The user can upload pictures of items he/she has already (such his/her own personal digital photographs) and make them part of a custom catalog. For example, if a person has a digital photograph of himself/herself in a black shirt 1001 and he/she wants to know how it looks with a certain top/shoes, the personal digital image 1001 of the shirt can be presented simultaneously (on the catalog or another “scratch pad” of some kind) on a computer with the top/shoes from an electronic catalog 1002 so he/she can see how well the shirt matches the top/shoes. As another example, the person is looking for a sofa to match curtains the person already owns. The person takes a pictures of the curtains, uploads it to his/her tablet and visually presents the image of the curtains with an image of the sofa taken from an electronic catalog to see how the two look together.

8.0 Additional Comments

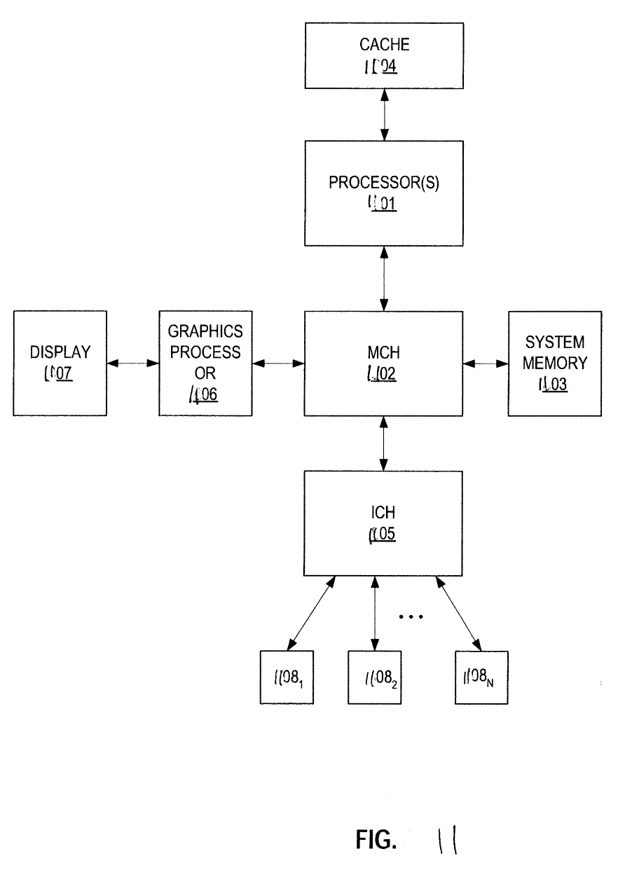

FIG. 11 shows an embodiment of a computing system (e.g., a computer which would be understood to include personal computer (PC), laptop, netbook, tablet computer, smartphone, etc.). The exemplary computing system of FIG. 11 includes: 1) one or more processing cores 801 that may be designed to include two and three register scalar integer and vector instruction execution; 2) a memory control hub (MCH) 802; 3) a system memory 803 (of which different types exist such as DDR RAM, EDO RAM, etc,); 4) a cache 804; 5) an I/O control hub (ICH) 805; 6) a graphics processor 806; 7) a display/screen 807 (of which different types exist such as Cathode Ray Tube (CRT), flat panel, Thin Film Transistor (TFT), Liquid Crystal Display (LCD), DPL, etc.) one or more I/O devices 808.

The one or more processing cores 801 execute instructions in order to perform whatever software routines the computing system implements. The instructions frequently involve some sort of operation performed upon data. Both data and instructions are stored in system memory 803 and cache 804. Cache 804 is typically designed to have shorter latency times than system memory 803. For example, cache 804 might be integrated onto the same silicon chip(s) as the processor(s) and/or constructed with faster SRAM cells whilst system memory 803 might be constructed with slower DRAM cells. By tending to store more frequently used instructions and data in the cache 804 as opposed to the system memory 803, the overall performance efficiency of the computing system improves.

System memory 803 is deliberately made available to other components within the computing system. For example, the data received from various interfaces to the computing system (e.g., keyboard and mouse, printer port, LAN port, modem port, etc.) or retrieved from an internal storage element of the computing system (e.g., hard disk drive) are often temporarily queued into system memory 803 prior to their being operated upon by the one or more processor(s) 801 in the implementation of a software program. Similarly, data that a software program determines should be sent from the computing system to an outside entity through one of the computing system interfaces, or stored into an internal storage element, is often temporarily queued in system memory 803 prior to its being transmitted or stored.

The ICH 805 is responsible for ensuring that such data is properly passed between the system memory 803 and its appropriate corresponding computing system interface (and internal storage device if the computing system is so designed). The MCH 802 is responsible for managing the various contending requests for system memory 803 access amongst the processor(s) 801, interfaces and internal storage elements that may proximately arise in time with respect to one another.

One or more I/O devices 808 are also implemented in a typical computing system. I/O devices generally are responsible for transferring data to and/or from the computing system (e.g., a networking adapter); or, for large scale non-volatile storage within the computing system (e.g., hard disk drive). ICH 805 has bi-directional point-to-point links between itself and the observed I/O devices 808.

Processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Peri, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.) or may be compiled directly into object code.

According to various approaches the abstract execution environment may convert the intermediate form program code into processor specific code by, 1) compiling the intermediate form program code (e.g., at run-time (e.g., a JIT compiler)), 2) interpreting the intermediate form program code, or 3) a combination of compiling the intermediate form program code at run-time and interpreting the intermediate form program code. Abstract execution environments may run on various operating systems (such as UNIX, LINUX, Microsoft operating systems including the Windows family, Apple Computers operating systems including MacOS X, Sun/Solaris, OS/2, Novell, etc.).

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
constructing an electronic catalog, said constructing including embedding in said electronic catalog a digital asset with an associated tag for triggering an automatic on line purchasing sequence and associated code for synchronizing comments made about said digital asset on said electronic catalog onto a social web site.

2. A method comprising:
displaying digital media content on a computer display;
in response to a user's input, incorporating a digital asset of said digital media content onto an electronic catalog.

3. A method, comprising:
receiving at a computer system changes, updates and/or promotions concerning items on an electronic catalog; and,
notifying a user of said computer system of any of said changes, updates and/or promotions.
